(19) United States
(12) Patent Application Publication
(10) Pub. No.: US 2010/0014188 A1
(43) Pub. Date: Jan. 21, 2010

(54) METHOD AND APPARATUS FOR APPROACHING A PREDETERMINED POSITION OF A CARRIER BELT WHICH MOVES IN ONE MOVEMENT DIRECTION

(75) Inventors: Jens-Uwe Timm, Muenchen (DE); Sigmund Niklas, Zell-Beucherling (DE); Joseph Forster, Oberhaching (DE); Heinrich Strobl, Kreuzhofstr (DE)

Correspondence Address: BLACK LOWE & GRAHAM, PLLC, 701 FIFTH AVENUE, SUITE 4800, SEATTLE, WA, 98104, US

(73) Assignee: Muehlbauer AG, Roding (DE)

(21) Appl. No.: 12/300,450

(22) PCT Filed: May 4, 2007
(86) PCT No.: PCT/EP2007/054354

§ 371 Date: May 18, 2009

(30) Foreign Application Priority Data
May 12, 2006 (DE) 10 2006 022 637.2

(51) Int. Cl. G11B 5/584

(52) U.S. Cl. 360/77.12; G9B/5.203

(57) ABSTRACT

The invention relates to a method for moving to a predetermined position of a carrier tape 2 moving continuously in a displacement direction, wherein a displacement head 4 is moved to the predetermined position, wherein the displacement head 4 is moved to the predetermined position in the displacement direction at a speed which corresponds essentially to the displacement speed of the carrier tape 2; wherein a procedure is carried out at the predetermined position on the moving carrier tape 2 by means of the displacement head 4.

The invention relates to a method for moving to a predetermined position of a carrier tape moving in a displacement direction, and to a movement apparatus.

In order to process components on a carrier tape and/or to deposit components on the carrier tape, use is usually made of a movement apparatus which, by means of a displacement head, can move towards specific positions on the carrier tape. To date, in order to deposit and/or process components on the carrier tape, or in general to carry out a procedure, the displacement head moves to a predetermined position and the carrier tape is stopped at the time of carrying out the procedure at the predetermined position so that the displacement head can carry out the predetermined procedure while the carrier tape is at a standstill. However, this has the disadvantage that the stopping and restarting of the carrier tape is very time-consuming, as a result of which the throughput of the arrangement as a whole is reduced. Furthermore, the carrier tape is subjected to stress on account of the discontinuous movement, as a result of which the carrier tape may in some circumstances be damaged, e.g. due to fatigue.

The object of the present invention is to avoid the abovementioned disadvantages and in particular to provide a method for moving to a predetermined position on a carrier tape and a movement apparatus, which allows an increased throughput and an increased service life of the system as a whole.

This object is achieved by the method according to claim 1 and by the movement apparatus according to claim 10.

Further advantageous embodiments of the invention are specified in the dependent claims.

According to a first aspect of the present invention, there is provided a method for moving to a predetermined position of a carrier tape moving continuously in a displacement direction. To this end, a displacement head is moved to the predetermined position in the displacement direction at a speed which corresponds essentially to the displacement speed of the carrier tape. The displacement head carries out a procedure at the predetermined position on the moving carrier tape, while both the carrier tape and the displacement head are moving in the displacement direction, in particular at the displacement speed.

As a result, the carrying-out of the procedure by the displacement head, in particular the depositing of a component on the carrier tape or the processing of a component on the carrier tape, can be carried out without there being any relative movement in the displacement direction between the displacement head and the carrier tape or the component located thereon at the time of carrying out the procedure.

In particular, the carrier tape is moved in such a way that it is displaced continuously in the displacement direction at a constant speed.

Furthermore, in order to move to the predetermined position, the displacement head may be moved transversely to the displacement direction of the carrier tape at a constant or variable transverse speed.

In order to avoid a relative transverse speed between the displacement head and the component when carrying out the procedure, it may be provided that, when carrying out the procedure, the transverse speed of the displacement head in a transverse direction, which runs transversely to the displacement direction of the carrier tape, is essentially zero.

According to a further embodiment of the invention, the displacement head may be moved in a straight line, in an arc shape or in rotation in order to move to the predetermined position.

As the procedure, the displacement head may deposit a component at the position, wherein preferably the component is picked up by the displacement head before moving to the predetermined position.

According to one preferred embodiment, a plurality of components are picked up and the plurality of components are deposited on the carrier tape one after the other by moving to a plurality of predetermined positions, wherein each of the components to be deposited at the corresponding predetermined position is moved in the displacement direction of the carrier tape at a speed which corresponds to the displacement speed of the carrier tape.

It may furthermore be provided that, as the procedure at the position, a component is processed, in particular bonded.

According to a further aspect of the present invention, there is provided a movement apparatus for moving to a predetermined position of a carrier tape moving continuously in a displacement direction. The movement apparatus comprises the carrier tape and a displacement head for carrying out a procedure at the predetermined position on the moving carrier tape. By means of a transport device, the displacement head can be moved in a transverse direction, which runs transversely to the displacement direction, and in the displacement direction, wherein the transport device is controlled by a control device so that the displacement head is moved to the predetermined position in the displacement direction at a speed which corresponds essentially to the displacement speed of the carrier tape.

Preferably, the control device controls the transport device in such a way that the displacement head, in order to move to the predetermined position, is moved in the transverse direction at a constant or variable transverse speed and that, when carrying out the procedure, the transverse speed in the transverse direction is essentially zero.

Preferably, the displacement head may be designed to deposit a component at a position. According to a further embodiment of the invention, the control device may control the transport device and the displacement head in such a way that a plurality of components are picked up and the plurality of components are deposited on the carrier tape one after the other by moving to a plurality of predetermined positions, and that each of the components to be deposited at the corresponding predetermined position is moved in the displacement direction at a speed which corresponds to the displacement speed of the carrier tape.

Preferred embodiments of the invention will be explained in more detail below with reference to the appended drawings, in which:

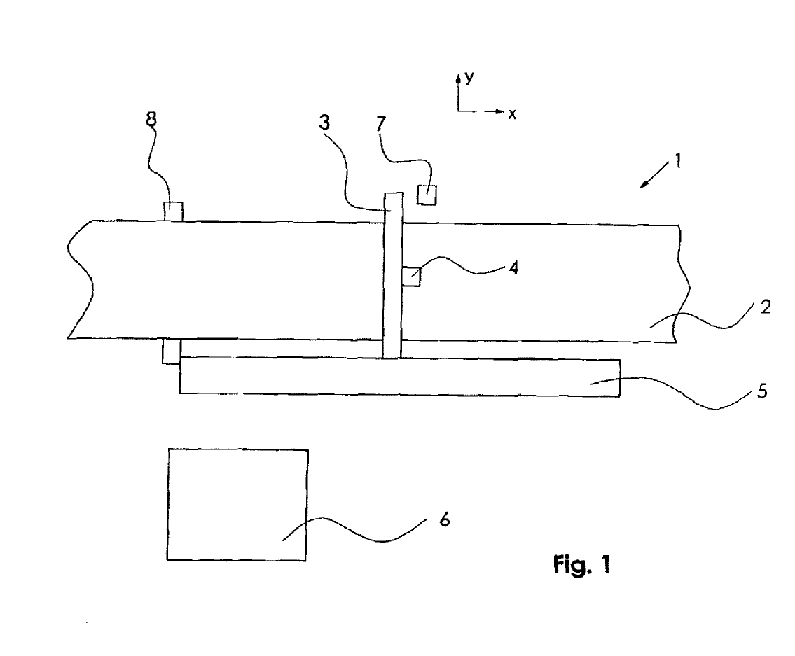

FIG. 1 shows a movement apparatus according to one embodiment of the present invention, and

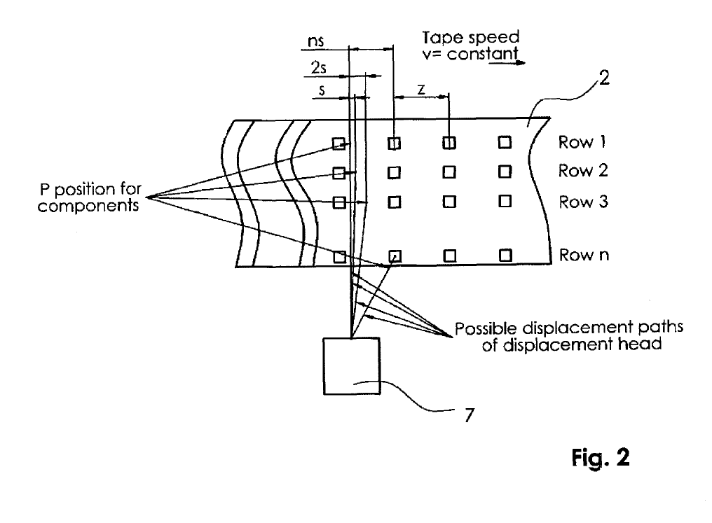

FIG. 2 shows a carrier tape with predetermined positions and possible displacement paths of the displacement head according to the embodiment of FIG. 1.

FIG. 1 shows a system 1 as a whole with a movement apparatus for moving to a position on a carrier tape 2 moving in a displacement direction. The movement apparatus comprises a carriage 3. A displacement head 4 is displaceably arranged on the longitudinal axis of the carriage 3, so that the displacement head 4 can be moved along the longitudinal axis of the carriage 3. The carriage 3 itself can be displaced along a rail 5 in a direction transverse to the longitudinal axis of the carriage 3, wherein the direction of the rail 5 preferably corresponds to the displacement direction.

The carriage 3 and the rail 5 are parts of a transport device, by means of which the displacement head 4 can be moved in an x direction and a y direction in the plane of the carrier tape 2. The transport device is controlled by a control unit 6, so that the movement apparatus carries out certain procedures by means of the displacement head 4 at the predetermined position of the carrier tape 2. The carrier tape is moved through a carrier tape unit, on which the carrier tape is at least partially placed, so that a support surface for the carrier tape 2 is provided in the movement area of the displacement head 4.

Such a movement apparatus is able to equip the carrier tape 2 with components, in particular electronic components such as capacitors, resistors, ICs and the like, at predetermined positions, i.e. in corresponding recesses of the carrier tape 2. Furthermore, such a movement apparatus can be used to process components in a certain way, said components being arranged at predetermined positions on the carrier tape 2. To this end, the displacement head 4 could be provided with corresponding processing units (not shown), such as for example a bonding unit, which applies bonding wires to components at predetermined positions, or with some other tool for processing the component.

If the movement apparatus is provided for equipping the carrier tape 2 with components, a pick-up point 7 is located outside the region of the carrier tape 2, at which pick-up point components can be provided in order to be picked up by the displacement head 4, which for this purpose may be provided for example with a pick-up unit. In this case, the displacement head 4 can pick up one or more of the components provided there and can transport them in a subsequent method step to the corresponding predetermined position on the carrier tape and place them there.

The carrier tape 2 is moved in the x direction at a continuous displacement speed by means of a drive device 8. In order to carry out the procedure at the predetermined position of the carrier tape 2, in particular to deposit a picked-up component or to process a component located there, it is necessary for the relative speed between the carrier tape 2 and the displacement head 4 to be as low as possible or equal to zero, so that the component can be deposited in a precise position or the component can be exactly processed at the predetermined position. For this reason, the carriage 3 is moved along the rail 5 in the x direction at the displacement speed of the carrier tape 2 at least at the time of carrying out the procedure, so that the relative speed between the displacement head 4 and the carrier tape 2 is equal to zero. At the time of carrying out the given procedure, the transverse speed in a transverse direction running transversely to the x direction, i.e. in the y direction, is preferably also equal to zero, in order to rule out any relative movement between the displacement head 4 and the carrier tape 2.

If a plurality of positions on the carrier tape 2 are to be arrived at one after the other, this may be achieved for example by moving the displacement head 4 in the y direction along the carriage 3 at a constant transverse speed or by reducing the transverse speed in the y direction to zero in order to move to each of the corresponding predetermined positions and then restarting the transverse movement of the displacement head 4 again once the predetermined procedure has been carried out, in order to move to the next corresponding position. The displacement head can be controlled in various ways, and the overall movement of the displacement head 4 may take place in an arc shape, in a straight line or in rotation.

FIG. 2 shows possible displacement paths of the displacement head for moving to a plurality of predetermined positions P (indicated by boxes) on the carrier tape 2. In the example of embodiment described above, the speed v of the carrier tape 2 is constant, but a variable speed may also be provided, although complete stopping of the carrier tape 2 so as to carry out the procedure should be avoided in order to prevent particular tensile stresses on the carrier tape 2 or a reduction in throughput due to the stopping and restarting of the carrier tape 2. However, during the carrying-out of the procedure by the displacement head, the carrier tape can be transported at a lower speed than the displacement speed v between the procedures, wherein the speed of the displacement head 4 in the x direction—controlled by the control device 6—is adapted according to the change in speed of the carrier tape 2.

A further advantage consists in that there is no need for an additional transport time of the displacement head in the x direction, since this movement takes place at the same time as the advance movement of the displacement head, i.e. the displacement head 4 follows the movement in the x direction of the carrier tape 2. Furthermore, the working field of the displacement head in the x direction remains constant even when there are different spacings between the predetermined positions, since the travel in the x direction can be determined by the speed of the web. This means that the size of the working field in the x direction or of the travel in the x direction of the displacement head can be influenced and controlled by the speed of the web. Instead of the previous cyclic drive of the carrier tape 2, a friction wheel drive can now be used for the carrier tape 2, and there is easier guidance of the carrier tape 2 and alignment thereof by means of the continuous movement. Furthermore, the predetermined positions can be arranged at will on the carrier tape 2, which was not the case before with cyclic operation due to the reduced number of stopping positions of the carrier tape on account of maximising the throughput.

The spacing z indicates the distance between die and die. n indicates the number of rows. S corresponds to the travel of the tape during one cycle.

All the features disclosed in the application documents are claimed as essential to the invention in so far as they are novel individually or in combination with respect to the prior art.

### LIST OF REFERENCES

1 system as a whole
2 carrier tape
3 carriage
4 displacement head
5 rail
6 control device
7 pick-up point
8 drive device

1. A method for moving to a predetermined position of a carrier tape moving continuously in a displacement direction, comprising the following steps:
moving a displacement head to the predetermined position, wherein the displacement head is moved to the predetermined position in the displacement direction at a speed which corresponds essentially to a displacement speed of the carrier tape; and
carrying out a procedure at the predetermined position on the moving carrier tape by means of the displacement head;
wherein components to be deposited at the corresponding predetermined position are moved in the displacement direction of the carrier tape at a speed which corresponds to the displacement speed of the carrier tape.

2. The method according to claim 1, wherein the carrier tape is displaced continuously in the displacement direction at a constant speed.

3. The method according to claim 1, wherein, in order to move to the predetermined position, the displacement head is moved transversely to the displacement direction of the carrier tape at a constant or variable transverse speed.

4. The method according to claim 1, wherein, when carrying out the procedure, the transverse speed in a transverse direction, which runs transversely to the displacement direction, is essentially 0.

5. The method according to claim 1, wherein the displacement head is moved in at least one of a straight line, an arc shape or in rotation in order to move to the predetermined position.

6. The method according to claim 1, wherein the procedure includes depositing a component at the position.

7. The method according to claim 6, wherein the component is picked up by the displacement head before moving to the predetermined position.

8. The method according to claim 7, wherein a plurality of components are picked up and the plurality of components are deposited on the carrier tape one after the other by moving to a plurality of predetermined positions.

9. The method according to claim, wherein the procedure at the position includes bonding component.

10. A movement apparatus for moving to a predetermined position of a carrier tape moving continuously in a displacement direction, comprising:
a displacement head for carrying out a procedure at the predetermined position on the moving carrier tape;
a transport device for moving the displacement head in a transverse direction, which runs transversely in the displacement direction; and
a control device which controls the transport device so that the displacement head is moved to the predetermined position in the displacement direction at a speed which corresponds essentially to the displacement speed of the carrier tape,
wherein components to be deposited at the corresponding predetermined position are moved in the displacement direction of the carrier tape at a speed which corresponds to the displacement speed of the carrier tape.

11. The apparatus according to claim 10, wherein the carrier tape is moved continuously in the displacement direction at a constant speed by means of a drive device.

12. The Movement apparatus according to claim 10, wherein the control device controls the transport device in such a way that, in order to move to the predetermined position, the component is moved in the transverse direction at least one of constant or variable transverse speed.

13. The apparatus according to claim 10, wherein the control device controls the transport device in such a way that, when carrying out the procedure, the speed in the transverse direction is essentially 0.

14. The apparatus according to claim 10, wherein the control device controls the transport device in such a way that the displacement head is moved in at least one of a straight line, an arc shape or in rotation in order to move to the predetermined position.

15. The Movement apparatus according to claim 10, wherein the displacement head is designed to deposit a component as the carried out procedure.

16. The apparatus according to claim 15, wherein the control device controls the transport device and the displacement head in such a way that the component is picked up by the displacement head before moving to the predetermined position.

17. The apparatus according to claim 16, wherein the control device controls the transport device and the displacement head in such a way that a plurality of components are picked up and the plurality of components are deposited on the carrier tape one after the other by moving to a plurality of predetermined positions, and in that each of the components to be deposited at the corresponding predetermined position is moved in the displacement direction at a speed which corresponds to the displacement speed of the carrier tape.

18. The apparatus according to claim 10, wherein the control device controls the transport device and the displacement head so as to bond a component as the carried out procedure.
